(19) United States
(12) Patent Application Publication
(10) Pub. No.: US 2004/0252004 A1
(43) Pub. Date: Dec. 16, 2004

(54) Thermoprotector

(76) Inventor: Eiichi Hashimoto, Gunma (JP)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/865,696

(22) Filed: Jun. 9, 2004

(30) Foreign Application Priority Data
Jun. 13, 2003 (JP) 2003-169186

(51) Int. Cl. H01H 37/52

(52) U.S. Cl. 337/85

(57) ABSTRACT

Moving contact pieces formed by plate spring members are fixed in the case with terminals, and first and second contacts are mounted on the other free ends of the moving contact pieces. A metal cover is mounted around the case, and a rectangular-shaped bimetal is fixed at one end to the cover so that a slider is interposed between the other free end of the bimetal and the second contact. The first and second contacts are held in contact with each other while ambient temperature is normal. An arcuate spring has one end positioned at a point S in the interior of the case and has the other end engaged at a point P with the extremity of the moving contact piece. As temperature excessively rises, the contacts are pushed by the free end of the bimetal through the slider, by which the arcuate spring causes the moving contact piece to perform a snap action to separate the first contact from the second contact.

### TECHNICAL FIELD

The present invention relates to a thermoprotector that senses an excessive rise of temperature and interrupts the electric circuit concerned.

### BACKGROUND ART

FIG. 5 schematically shows an example of a conventional thermoprotector of this kind. The prior art thermoprotector, denoted generally by 10, has a construction in which: a contact spring 2 carrying at its one end a moving contact 1 fixed thereto and a fixed contact 3 are fixedly secured to an open-topped insulating case 4, together with terminals 5a and 5b; a guide member 7 having supported therethrough a vertically moving push rod 6 made of an insulating material is mounted on the open end of the insulating case 4; a disc-shaped bimetal 8 is placed above the guide member 7; and a metal cap 9 is put on the guide member 7 from above the disc-shaped bimetal 8 and crimped onto the insulating case 4.

In the thermoprotector of the above construction, when temperature (ambient temperature) excessively rises in excess of a predetermined temperature to reach the abnormal-state (FIG. 5B) from the steady-state (FIG. 5A), the high and low expansion sides of the disc-shaped bimetal 8 are reversed with a snap action, with the result that the push rod 6 is pressed down, pushing the contact spring 2 and hence bringing the moving contact out of contact with the fixed contact 3. The conventional thermoprotector 10 is configured to interrupt the electric circuit through utilization of a reversing motion of the disc-shaped bimetal 8 as mentioned above (see, for example, Japanese Utility Model Publication No. S58-46497).

In the interruption of an electric circuit by such a thermoprotector, it is desirable to provide a large contact separation and a sufficiently high contact opening speed. The conventional thermoprotector of the type utilizing the snap action of the disc-shaped bimetal is configured to fully satisfy the above requirements, but the use of such the disc-shaped bimetal presents the problem described below.

The disc-shaped bimetal is usually produced by binding together two metal discs with different coefficients of thermal expansion by fusion welding or brazing, followed by press working into a curved disc-shape. The disc shape readily varies, and the variation of the disc shape causes variations in the temperature at which the disc-shaped bimetal is reversed. To avoid this, it is necessary to preheat disc-shaped bimetals to select those which operate at a predetermined temperature. For efficient manufacturing, such screening process of disc-shaped bimetals, for example, should be provided prior to automatic assembling of thermoprotectors, so that a large amount of capital investment is required.

A substitution for the disc-shaped bimetals may be rectangular-shaped bimetals. Because of their simple configuration, rectangular-shaped bimetals are easy of fabrication and those of uniform property are readily available. They are suitable for use as thermostats as set forth, for example, in Published Japanese Utility Model Application No. S58-57050, but they are difficult to perform a snap action. For this reason, it has been considered impossible to apply the rectangular-shaped bimetals to the thermoprotector that is required to achieve a large contact separation and a sufficiently high contact opening speed.

### DISCLOSURE OF THE INVENTION

It is therefore an object of the present invention to provide a high-performance but low-cost thermoprotector that uses the rectangular bimetal and hence does not involve a large amount of capital investment needed in the past for screening bimetal discs.

The thermoprotector of the present invention uses, in combination, the rectangular bimetal and an arcuate spring for performing a snap action of a moving contact piece.

According to the present invention, there is provided a thermoprotector which comprises: a case made of an insulating resin material; a pair of terminals secured to the case; a pair of first and second moving contact pieces having their base ends secured to the terminals, respectively, and have their free ends extended in the case in opposing relation to each other, the first and second moving contact pieces being formed of a plate spring material; a pair of first and second contacts mounted respectively on the free ends of the first and second moving contact pieces near their extremities in opposing relation to each other; a metal cover put on the case in a manner to surround the case; a rectangular-shaped bimetal disposed on the inside of the cover and fixed at one end to the cover and free at the other end; a slider interposed between the free end of the bimetal and the free end of the second moving contact piece; and an arcuate spring having one end positioned at a groove formed in the interior surface of the case and the other free end engaged with an extremity of the first moving contact piece located on the side opposite to the slider with respect to the second moving contact piece; wherein: under a steady-state temperature condition not in excess of a predetermined temperature, the arcuate spring is not deformed so that the arcuate spring pushes the first contact against the second contact to bring the first and second contacts into contact with each other; and under an abnormally high temperature condition in excess of the predetermined temperature, the bimetal is deformed to press by its free end, through the slider, the second contact against the first contact, so that the arcuate spring causes the first moving contact piece to perform a snap action, bringing the first contact out of contact from the second contact.

### BRIEF DESCRIPTION OF THE DRAWINGS

FIG. 1A is a plan view of a thermoprotector according to an embodiment of the present invention;

FIG. 1B is its left side view;

FIG. 1C is its front view;

FIG. 1D is a sectional view taken along the line A-A in FIG. 1A;

FIG. 1E is a perspective view for explaining the engagement of an arcuate spring and a moving contact piece;

FIG. 2A is a left side view of a case in the FIG. 1 embodiment;

FIG. 2B is its front view;

FIG. 2C is its right side view;

FIG. 2D is its bottom view;

FIG. 2E is a sectional view taken along the line F-F in FIG. 2B;

FIG. 2F is a perspective view of a cover for covering an opening of the case; FIG. 3A is a developed view of the cover in the FIG. 1 embodiment;

FIGS. 3B to 3E are its rear, left side, front, and right side views, respectively;

FIG. 3F is a sectional view taken along the line G-G in FIG. 3D;

FIGS. 4A to 4C are sectional views of thermoprotector of the FIG. 1 embodiment, for explaining its operation;

FIGS. 5A and 5B are sectional views of a conventional thermoprotector, for explaining its operation.

### BEST MODE FOR CARRYING OUT THE INVENTION

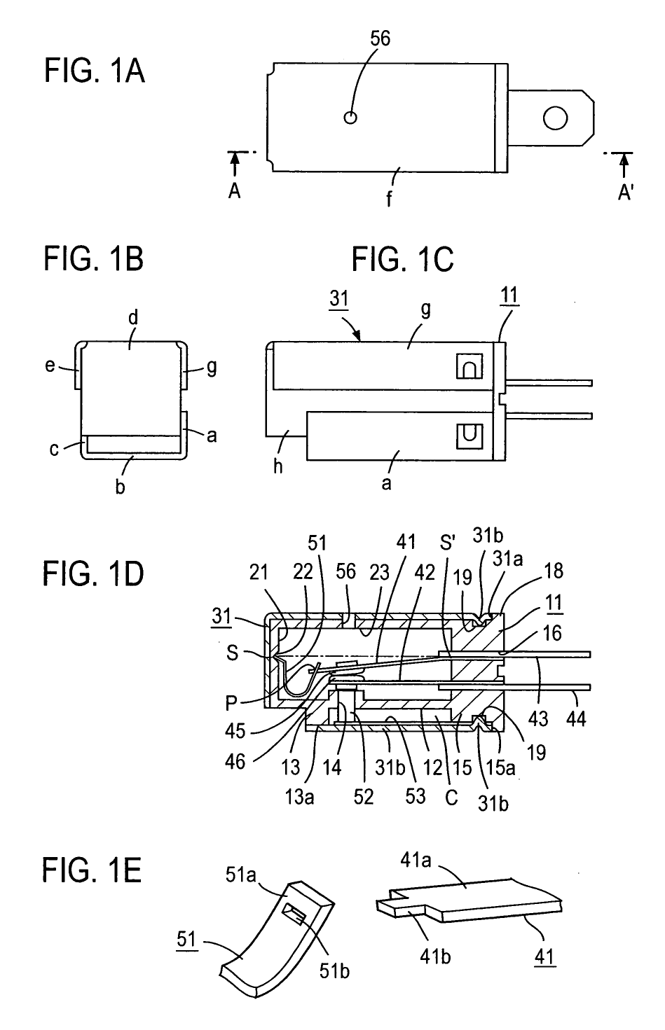

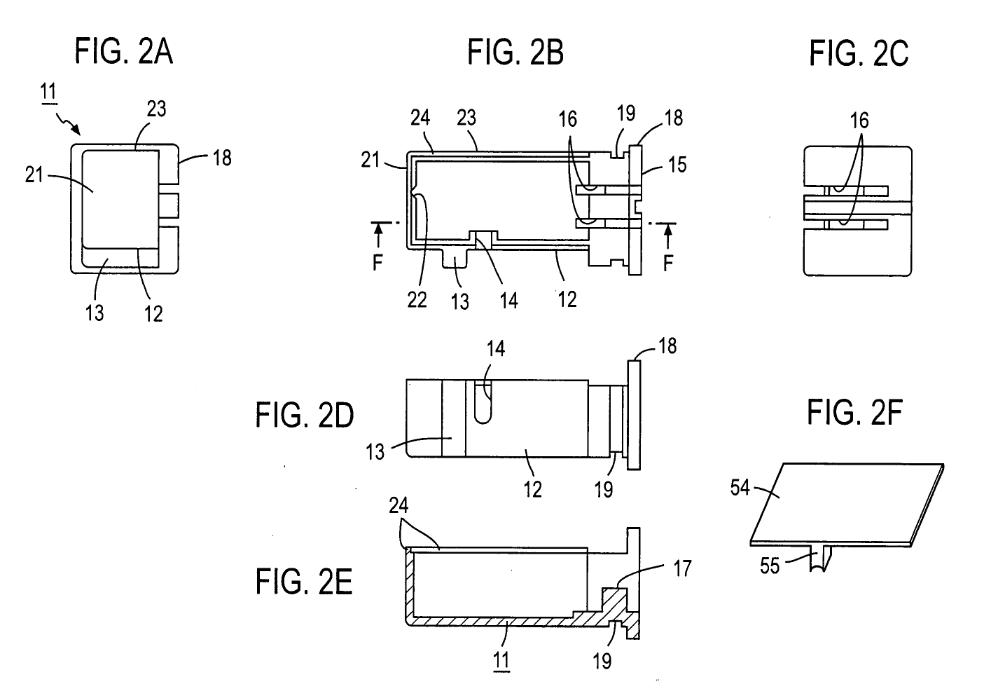

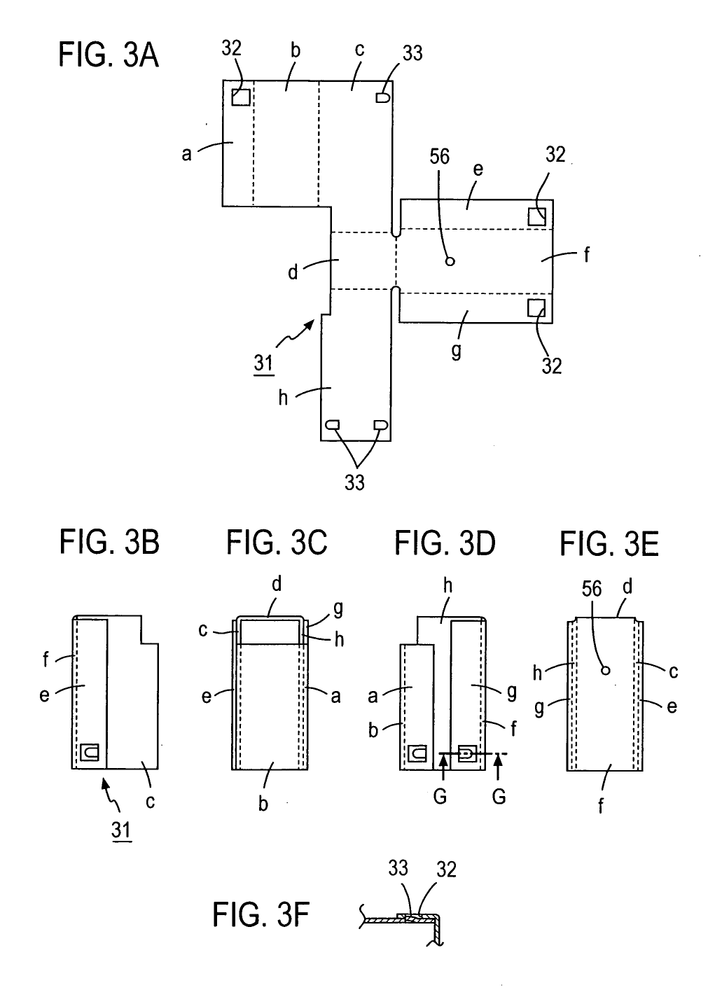

FIG. 1 schematically illustrates an embodiment of the thermoprotector 101 according to the present invention. FIGS. 2 and 3 show a case 11 and a cover 31 that are constituent parts of the thermoprotector, respectively. A description will be given first, with reference to FIGS. 2 and 3, of the constructions of the case 11 and the cover 31.

The case 11 is a rectangular box open at one side (the front side of the box in its front view shown in FIG. 2B). The case 11 is made of an insulating resin material. On the underside of a bottom panel 12 of the box-shaped case 11 there is protrusively provided a rectangular protrusion 13 extending in parallel to the shorter sides of the bottom panel 12. The bottom panel 12 has formed therein an elliptic notch 14 extending from the opening side of the case 11 along the protrusion 3 to a position intermediate the width of the bottom panel 12.

The right-hand side panel 15 of the case 11 adjacent to the opening is formed thick. The right side panel 15 has formed therethrough a pair of slits 16 open at one end to the interior to the case 11. In the portion underlying the pair of slits 16 there is formed a protrusion 17 as shown in FIG. 2E.

The thick right side panel 15 has a flange-like stepped portion 18 protruding from its outer end on all sides thereof, and just inside the stepped portion 18 there is formed a groove 19 of U-section extending along three surfaces of the right side panel 15 except the opening of the case 11.

In the interior surface of the left-hand side panel 21 opposite to the right side panel 15 in the longitudinal direction of the case 11 there is formed a V groove 22. The left side panel 21, the bottom panel 12 and the top panel 23 of the case 11 have a stepped portions 24 slightly protruding from their end edges surrounding the opening of the case 11.

The cover 31 is mounted around the case 11. It is formed by folding a metallic plate of a required shape; the metallic plate used in this example is an aluminum (Al) plate of high thermal conductivity.

FIG. 3A is a developed view of the cover 31. The broken lines indicate folding lines of the metallic plate. The plate is folded along the folding lines to form such a box-shaped cover 31 as shown in FIGS. 3B to 3E. To facilitate better understanding of their overlapping, the areas defined by folding the metallic plate are identified by reference characters a to h, respectively. In FIG. 1, too, the same reference characters are used. As shown in FIG. 3A, the cover 31 has square holes 32 made in the plate at three places, which are connected, as depicted in FIG. 3F, with turned-out lugs 33 on the metallic plate at the positions corresponding to the square holes 32 when the plate is folded into the box-shaped cover 31. By engaging the square holes 32 and the turned-out lugs 33 as shown in FIG. 3F, respective parts of the box-shaped cover 31 are fixedly secured to one another.

Turning back to FIG. 1, the construction and assembling of the thermoprotector will be described.

First and second moving contact pieces 41 and 42, formed by plate spring members as of phosphor bronze, are fixed at their base end to terminals 43 and 44, respectively. The overlapping portions of the terminals 43, 44 and the first and second moving contact pieces 41, 42 are press-inserted in the slits 16 of the case 11. The terminals 43 and 44 are made of brass, for instance, and the first and second moving contact pieces 41, 42 and the terminals 43 and 44 are secured to each other by welding in this example.

In those portions of the case 11 where the overlapping portions of the terminals 43, 44 and the moving contacts 41, 42 are press-fitted in the slits 16, there are formed rectangular notches (hidden in FIG. 1D). The terminals 43, 44 and the moving contacts 41, 42 are positioned by engagement of the notches with the protrusions 17 underlying the slits 16.

The first and second moving contact pieces 41 and 42 inserted in the case 11 and disposed opposite each other cany at their extremities or their other free ends a pair of the first and second contacts 45 and 46 in opposing relation. In this example, the first moving contact piece 41 is slightly bent downward in the vicinity of its base end so that the contacts 45 and 46 engage each other. The contact 45 and 46 are made of a silver alloy, for instance.

An arcuate spring 51 is interposed between the free end of the first moving contact piece 41 and the panel 21 of the case 11. The arcuate spring 51 has its one end fitted in the V groove 22 in the panel 21 and located at a position S and has its other free end engaged with the free end of the moving contact piece 41 at a position P. The arcuate spring 51 is placed with its concavity upward.

As depicted in FIG. 1E, the arcuate spring 51 has a rectangular hole 51b formed therethrough near its other free end 51a for receiving a projection 41b from the free end portion 41a of the first moving contact piece 41. Through engagement of the hole 51b and the projection 41b the first moving contact piece 41 and the arcuate spring 51 are movably connected together at the point P so as to allow the arcuate spring 51 to provide a snap action to the first moving contact piece 4. The arcuate spring 51 is formed as of phosphor bronze as is the case with the first and second moving contact pieces 41 and 42.

The first moving contact piece 41 has been described in the above as being slightly bent downward at the point near its base end in FIG. 1D. This will be described below in more detail. In the initially assembled state (in the state of operation at normal temperature) the first moving contact piece 41 is bent downward so that the point of engagement P between the projection 41b from the free end of the moving contact piece 41 and the hole 51b of the arcuate spring 51 lies below a plane (hereinafter referred to as a plane S-S′) normal to the plane of paper (the drawing) that contains a line (indicated by S-S′ in FIG. 1D) joining the position S where the one end of the arcuate spring 51 is positioned in the V groove 22 cut in the panel 21 of the case 11 and the position S′ where the base of the first moving contact piece 41 is fixed to the case 11. As a result, the point of engagement P is located below the plane S-S′ in FIG. 1D; hence, under a downward load by the arcuate spring 51 the other free end of the first moving contact piece 41 is further pressed down against the other free end of the second moving contact piece 42.

In the elliptic notch 14 of the case 11a columnar slider 52 of insulating resin is received movably in its axial direction. On the top end of the slider 52 is rested the free end portion of the second moving contact piece 42.

The slider 52 is first inserted in the elliptic notch 14 and then positioned by fitting into the opening of the case 11a cover 54 having a positioning piece 55 as shown in FIG. 2F. Thus the slider 52 is put between the positioning piece 55 and the inner wall of the elliptic notch 14 and hence positioned at the innermost end of the notch 14. The stepped portions 24 slightly projecting from the marginal edges of the case 11 surrounding its opening are used to mount (or position) the cover 54 on the case 11.

The cover 31 is put on the case 11 from the side of its left-hand side panel 21 until the open end 31a of the cover 31 becomes in abutting relation to the stepped portion 18 of the case 11 (see FIG. 1D). The cover 31 is then fixedly secured to the case 11 by crimping the open end portion 31b of the former into the U groove 19 of the latter.

That portion 31b of the cover 31 underlying the bottom panel 12 of the case 11 is in abutting relation to the lower end 13a of the protrusion 13 and a stepped portion 15a of the thick portion 15 protruding downward in the same manner as does the protrusion 13, this defines predetermined cavity C between the cover 31 and the bottom panel 12 of the case 11.

In the cavity C there is disposed a rectangular-shaped bimetal 53 which has one end fixed to the right-hand side 15 of the case and the other free end. The above-mentioned slider 52 is interposed between the free end of the bimetal 53 and the second moving contact piece 42. Accordingly, the first moving contact piece 41, bent downward, presses against the second moving contact piece 42 supported upward by the slider 52, holding the contacts 45 and 46 in close contact with each other.

The fixed end of the bimetal 53 is welded to the cover 31 in this example, and the bimetal 53 extends along the cover 31 in close contact therewith. The side of the bimetal 53 in close contact with the cover 31 is the high expansion side and the other side is the low expansion side. The cover 31 with such a bimetal 53 mounted therein is put on the case 11.

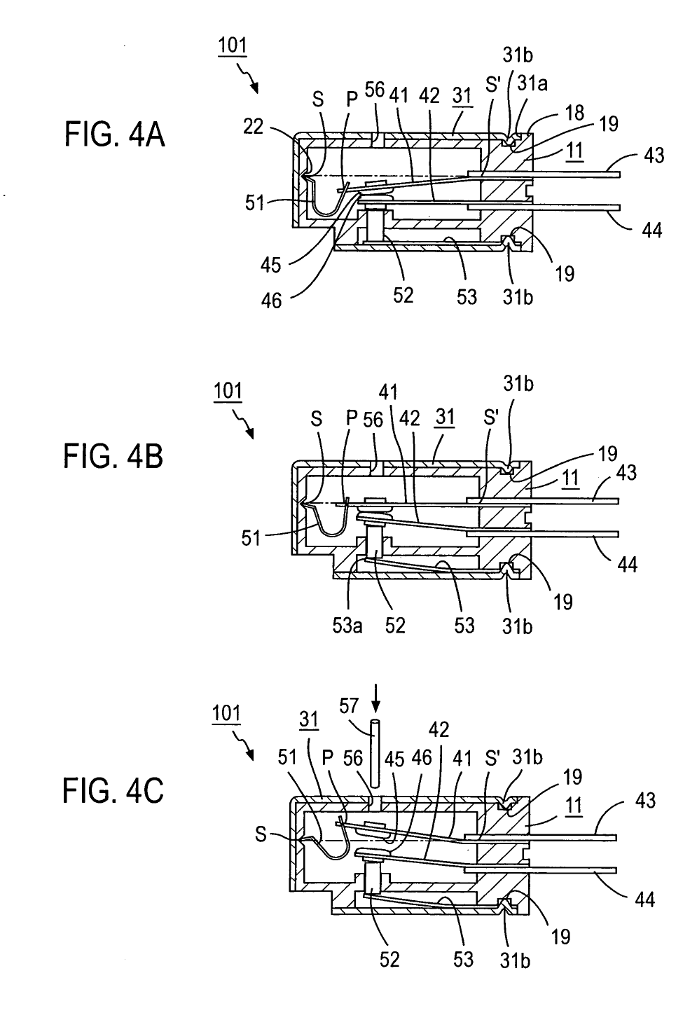

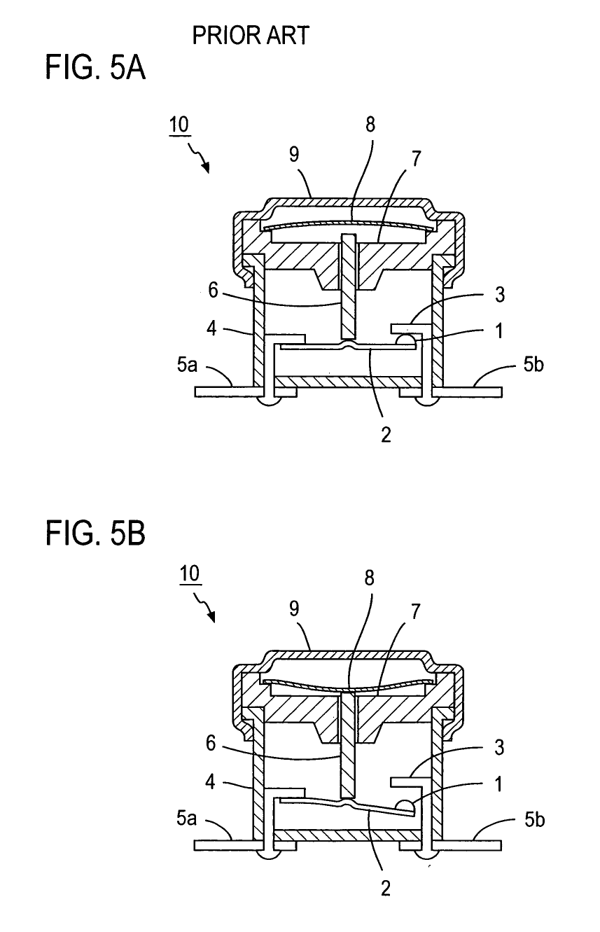

FIG. 4 depicts operations of the thermoprotector structured as described above. A description will be given below of operations of the thermoprotector in respective states.

FIG. 4A: Initial State

Since the first moving contact piece 41 is slightly bent downward as described previously with reference to FIG. 1D, the point of engagement P of the arcuate spring 51 with the projection 41b from the first moving contact piece 41 overlying the second moving contact piece 42 stays under the plane S-S′ which contains the line S-S′ joining the position S where the arcuate spring 51 is located at one end in the V groove of the case 11 and the position S′ where the first moving contact piece 41 has its base end fixed to the case 11. The arcuate spring 51 is disposed with its concavity directed toward the top panel 23 of the case 11. That is, the arcuate spring 51 has its concavity directed in the upward direction in which the slider 52 is urged to move by the rectangular-shaped bimetal 53 at abnormally high temperatures. On this account, the contacts 45 and 46 are held in contact with each other by the downward load of the arcuate spring 51. The terminals 43 and 44 are electrically connected via the first and second moving contact pieces 41, 42 and the contacts 45, 46.

FIG. 4B: Heating-Up State

As ambient temperature rises, the bimetal 53 bends and raises its free end 53a. The slider 52 is pressed upward by the free end 53a of the bimetal 53, and consequently the contacts 45 and 46 are brought up. Since the first and second moving contact pieces 41 and 42 are both made of a spring material, the contacts 45 and 46 can be displaced vertically by the slider 52. In this situation, the ambient temperature still remains below the predetermined temperature. The contacts 45 and 46 are, thus held in contact with each other since the point of engagement P does not go up beyond the plane S-S′.

FIG. 4C: Interruption State

As temperature further rises, displacement of the bimetal 53 also increases, further pushing up the contacts 45 and 46. At the instant when the ambient temperature rises in excess of the predetermined temperature, the point of engagement P between the arcuate spring 51 and the first moving contact piece 41 goes beyond the plane S-S′, the direction of application of the load of the arcuate spring 51 is reversed from downward to upward, by which the first moving contact piece 41 is thrust up with a snap action together with the arcuate spring 51, bringing the first contact 45 out of engagement with the second contact 46 and hence disconnecting the terminals 43 and 44.

As described above, according to this example, the first moving contact piece 41 is caused to perform a snap action by means of the arcuate spring 51, even though the rectangular-shaped bimetal 53 is used instead of the conventional disc-shaped one. The rectangular-shaped bimetal 53 simultaneously pushes up through the slider 52 both of the contacts 45 and 46 carried by the first and second moving contact pieces 41 and 42 at their free ends, thereby actuating the arcuate spring 51 to interrupt the electrical circuit. Incidentally, when the steady-state temperature is restored after the bimetal 53 sensed an abnormal temperature rise and the first contact 45 was put out of contact with the second contact 46 as shown in FIG. 4C, the thermoprotector can be reset to its initial state shown in FIG. 4A by pushing back the moving contact piece 41 downward (as indicated by the arrow in FIG. 4C) with, for example, an insulator rod 57 that is inserted into the case 11 through a hole 56 formed through the top panels of the cover 31 and the case 11.

### INDUSTRIAL APPLICABILITY

As described above, according to the present invention, since the rectangular-shaped bimetal is used, bimetals of uniform quality are easily available, and there is no need of an automatic screening facility for screening bimetals prior to assembling as required in the case of using conventional disc-shaped bimetals. This makes unnecessary a large amount of capital investment for such screening of bimetals, making the thermoprotector less expensive accordingly.

Since the interrupting operation is performed through utilization of a snap action of the first moving contact piece 41 that is caused by a change in the position of the point P of engagement between the arcuate spring 51 and the first moving contact piece 41, an extremely large contact separation and a sufficiently high contact opening speed can be obtained during the interrupting operation. Hence, the thermoprotector of the present invention is high-performance.

Furthermore, when the second contact 46 is pushed up by the slider 52, the first contact 45 is also pushed up at the same time, so that their contact pressure is maintained until immediately before the interrupting operation. This is an excellent operation/working-effect of the present invention.

Since the first and second moving contact pieces 41, 42 and the bimetal 53 are both in the form of a rectangular plate spring, their performance can be adjusted simply by bending them to desired angles. Accordingly, by incorporating such an adjustment step in the assembling process, it is possible to save defective pieces, sharply improving their yields.

What is claimed is:

1. A thermoprotector comprising:
a case made of an insulating resin material;
a pair of terminals secured to said case;
a pair of first and second moving contact pieces having their base ends secured to said terminals, respectively, and have their free ends extended in said case in opposing relation to each other, said first and second moving contact pieces being formed of a plate spring material;
a pair of first and second contacts mounted respectively on the free ends of said first and second moving contact pieces near their extremities in opposing relation to each other;
a metal cover put on said case in a manner to surround said case;
a rectangular-shaped bimetal disposed on the inside of said cover and fixed at one end to said cover and free at the other end;
a slider interposed between the free end of said bimetal and the free end of said second moving contact piece; and
an arcuate spring having one end positioned at a groove formed in the interior surface of said case and the other free end engaged with an extremity of said first moving contact piece located on the side opposite to said slider with respect to said second moving contact piece;
wherein:
under a steady-state temperature condition not in excess of a predetermined temperature, said arcuate spring is not deformed so that said arcuate spring pushes said first contact against said second contact to bring said first and second contacts into contact with each other; and
under an abnormally high temperature condition in excess of the predetermined temperature, said bimetal is deformed to press by its free end, through said slider, said second contact against said first contact, so that said arcuate spring causes said first moving contact piece to perform a snap action, bringing said first contact out of contact from the second contact.

2. The thermoprotector according to claim 1, wherein:
under said steady-state temperature condition, the point of engagement of said arcuate spring with the extremity of the free end of said first moving contact piece is located on the same side as the free end of said second moving contact piece with respect to a plane which contains a straight line joining the position where said one end of said arcuate spring is positioned and the position where one end of said first moving contact piece is fixed; and
under said abnormally high temperature condition, said point of engagement is located on the side opposite to the side where the free end of said second moving contact piece stays with respect to said plane.

3. The thermoprotector according to claim 1, wherein:
said arcuate spring is disposed with its concavity held in the direction in which said slider is pushed by said bimetal due to its deformation.
